(19) United States
(12) Patent Application Publication
(10) Pub. No.: US 2009/0039030 A1
(43) Pub. Date: Feb. 12, 2009

(54) ANTIMICROBIAL WATER TREATMENT SYSTEM AND METHOD

(76) Inventor: Conrad S. Revak, Willoughby Hills, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/834,147

(22) Filed: Aug. 6, 2007

(51) Int. Cl. C02F 1/02; C02F 1/00; C02F 1/68; E04H 4/16

(52) U.S. Cl. 210/742; 210/167.1; 210/167.3; 210/167.32; 210/175; 210/764; 210/765; 210/766

(57) ABSTRACT

A system and method is described for destroying microbes in water from bathing apparatuses, such as swimming pools, using heat. Part of the stream from the pool is diverted, heated to an antimicrobial temperature, and recombined as a merged stream before it reenters the pool at a safe temperature. Further embodiments include addition of chemical antimicrobial agents, a controller, a storage vessel, and a cooler. Operating costs will increase little, if any, as compared with a conventional system.

### TECHNICAL FIELD

The present invention relates generally, as indicated, to antimicrobial water treatment systems and methods of destroying microbes in bodies of water. More particularly, the invention relates to an antimicrobial water treatment system and method useful to destroy microbes in water from bathing apparatuses, for example, in the form of swimming pools, hot tubs, whirlpools, spas, etc. (hereafter, for brevity, generally referred to as “pool” or “container”).

### BACKGROUND

Pools are commonly used for recreational and therapeutic purposes. However, pool water must be treated to allow for safe usage. Common pool water treatment systems include disinfection. Pool water disinfection includes controlling the level of microbes, also referred to as microorganisms, in the pool water. Disinfect, as it applies to this invention, means to lower the microbial concentration in the water, but not necessarily to reduce it to zero concentration.

Pool water disinfection systems are commercially available to reduce microbe levels in pools, e.g., to destroy bacteria, viruses, protozoa, fungi, etc., which may contaminate the water. For example, chemical treatment systems that use active compounds, for example chlorine, neutralize microbes in the pool water.

A chemical disinfection system must keep chemical concentrations high enough to keep microbes at an acceptably low level, while also keeping the chemical concentrations low enough to maintain a safe, recreational environment for the users of the pool. Common approaches to introducing chemicals to the pool water include devices in-line with a water circulation system, floating devices, and manual introduction.

Pool heaters and thermal covers can be used to warm the pool water to a temperature comfortable for bathing or recreational use. The heater is usually located in-line with the water circulation system. A conventional heater system is one that draws water from the pool, heats it to a safe temperature, and returns it to the pool.

A consequence of heating pool water can be an increase in microbe levels. The number of microbes in pool water typically increases as water temperatures approach human body temperature. Some microbes are particularly adapted to grow at 98.6 degrees Fahrenheit.

### SUMMARY

Aspects of the present invention are directed to antimicrobial water treatment systems and methods.

According to an aspect of the invention, a portion of a stream of water from a pool is diverted, is heated to an antimicrobial temperature, and is recombined with the other portion of the stream as a merged stream, and the merged stream may be provided for reentry to the pool at a safe temperature.

According to several other aspects of the invention, chemical antimicrobial agents may be added to the stream, to one or more portions of the stream, and/or to the merged stream; a storage vessel may contain some or all of the diverted portion of water to maintain antimicrobial water temperature; a cooler may cool water prior to reentry into the pool; and/or a control system may control the various processes.

According to another aspect, the antimicrobial water treatment system includes a water container adapted for full or partial immersion therein of a human or other animal and a heater to heat at least some of the water of the container to a temperature adequate to destroy at least some microbes in the water.

According to another aspect, the antimicrobial water treatment system includes a water circulation system fluidically coupled to the water container such that water flows from the water container, through the water circulation system, and back to the water container.

According to another aspect, the antimicrobial water treatment system includes a water circulation system adapted to separate water flowing through the water circulation system into a main stream and a heated stream, and wherein water in the heated stream is heated to the temperature adequate to destroy at least some microbes in the water.

According to another aspect, the antimicrobial water treatment system includes a main stream recombined with a heated stream to create a merged stream after the water in the heated stream is heated.

According to another aspect, the antimicrobial water treatment system includes a container that is a pool or spa, wherein water from the container is provided to the main stream from the pool or spa and the merged stream is provided to the pool or spa.

According to another aspect, the antimicrobial water treatment system includes a bypass valve adapted to control the flow of water from the water circulation system to the heated stream, a merged stream temperature sensor to monitor the merged stream water temperature before the water returns to the water container, and a controller adapted to regulate the bypass valve as a function of the merged stream water temperature.

According to another aspect, the antimicrobial water treatment system includes a container water temperature sensor, wherein the controller additionally monitors the container water temperature.

According to another aspect, the antimicrobial water treatment system includes a heated stream temperature sensor, wherein the controller additionally monitors the heated stream water temperature after the water is heated.

According to another aspect, the antimicrobial water treatment system includes a controller that additionally regulates the heat output of the heater.

According to another aspect, the antimicrobial water treatment system includes a container water temperature sensor and a heated stream temperature sensor, wherein the controller additionally monitors the container water temperature and the heated stream water temperature after the water is heated and additionally regulates the heat output of the heater.

According to another aspect, the antimicrobial water treatment system includes an antimicrobial chemical agent adequate to destroy at least some microbes in the water.

According to another aspect, the antimicrobial water treatment system includes an antimicrobial chemical agent adequate to destroy at least some microbes in the water in the heated stream.

According to another aspect, the antimicrobial water treatment system includes a storage vessel adapted to maintain the water in the heated stream at an elevated temperature.

According to another aspect, the antimicrobial water treatment system includes a mechanical filter adapted to remove debris from the water in the water circulation system.

According to another aspect, the antimicrobial water treatment system includes a cooler adapted to cool the water in the water circulation system.

According to another aspect, the antimicrobial water treatment system includes a cooler water temperature sensor to monitor the temperature of the water coming out of the cooler and a controller adapted to regulate the cooling rate of the cooler as a function of the temperature of the water coming out of the cooler.

According to another aspect, the antimicrobial water treatment system includes an outlet adapted to direct water from the water container to circulate through the water circulation system, a pump adapted to circulate the water through the water circulation system, tubing adapted to pass the water through the water circulation system, and an inlet adapted to direct water from the water circulation system to return to the water container.

According to another aspect, a method of reducing microbes in water of a water container adapted for full or partial immersion therein of a human or other animal, including the step of heating at least some of the water to a temperature adequate to destroy at least some microbes in the water.

According to another aspect, the method further includes the step of passing water in the water container through a water circulation system.

According to another aspect, the method further includes the steps of removing water from the water container using the water circulation system and returning the water to the water container using the water circulation system.

According to another aspect, the method further includes the step of separating the water flowing through the water circulation system into a main stream and a heated stream, wherein water in the heated stream is heated to the temperature adequate to destroy at least some microbes.

According to another aspect, the method further includes the step of recombining the heated water in the heated stream with the water in the main stream to create a merged stream.

According to another aspect, the method further includes the steps of monitoring the merged stream water temperature before the water returns to the water container and regulating the heated stream flow rate to achieve a desired level of heating.

According to another aspect, the method further includes the step of monitoring the water container water temperature.

According to another aspect, the method further includes the step of monitoring the heated stream water temperature.

According to another aspect, the method further includes the step of regulating the heat output of a heater.

According to another aspect, the method further includes the steps of monitoring the water container water temperature, monitoring the heated stream water temperature, and regulating the heat output of a heater.

According to another aspect, the method further includes the step of exposing at least some of the water to an antimicrobial chemical agent adequate to destroy at least some microbes.

According to another aspect, the method further includes the step of exposing the water in the heated stream to an antimicrobial chemical agent adequate to destroy at least some microbes in the water in the heated stream.

According to another aspect, the method further includes the step of storing the water in the heated stream at an elevated temperature to further destroy microbes.

According to another aspect, the method further includes the step of passing the water in the water circulation system through a mechanical filter adapted to remove debris.

According to another aspect, the method further includes the step of cooling the water in the water circulation system in order to destroy more microbes by operating the heater at a higher temperature.

According to another aspect, the method further includes the steps of monitoring the temperature of the water coming out of a cooler and regulating the cooling rate of the cooler as a function of the temperature of the water coming out of the cooler.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic illustration showing a pool employing an antimicrobial water treatment system of the present invention; and

FIG. 2 is a schematic illustration showing a pool employing another embodiment of the antimicrobial water treatment system.

### DETAILED DESCRIPTION OF EMBODIMENTS

While the invention has many other uses, a major application lies in the disinfection of pool water of a swimming pool, hot tub, whirlpool, spa, or other container that is adapted for full or partial immersion therein of a human or other animal. The invention may also be configured to disinfect water of an aquarium, tank, or similar container of water adapted to house plants, fish, coral, or other animals. The embodiment of the invention selected for illustration is described in relation to that use and for brevity is described with regard to a pool, e.g., a swimming pool. However, it will be appreciated that the invention may be used with other containers.

Heating pool water to temperatures suitable for destroying microbes is effective for disinfection purposes, but may result in water too hot for human contact. However, as seen in the embodiments below, combining disinfected hot pool water with cooler pool water results in water that is both disinfected and safe to introduce or to reintroduce to the pool.

A conventional pool heater warms the water without disinfecting it. That is, the thermal energy is wasted in regard to disinfecting purposes. In this invention the thermal energy of the heater into the system is utilized to achieve a disinfecting action on some of the water while maintaining safety. By recirculation, the microbial level is continually reduced.

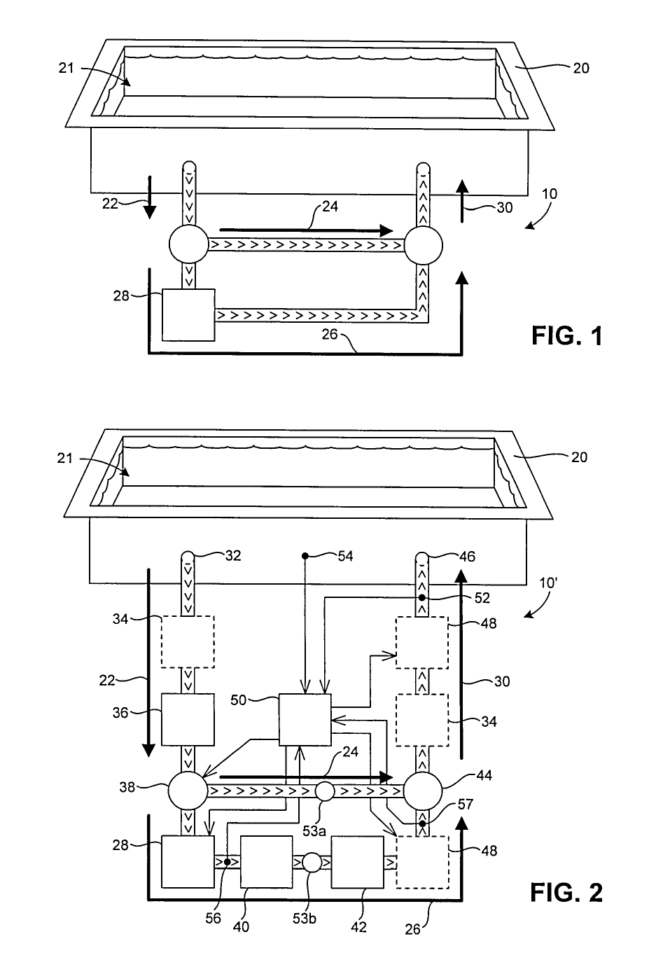

Referring in detail to the drawings, wherein like reference numerals designate like parts in the figures, and initially to FIG. 1, an antimicrobial water treatment system 10 in accordance with the present invention, coupled to a pool 20. Generally, the system 10 may be used to remove water from the pool 20, treat the water from the pool 20 using heat to destroy microbes in the water, and return the water to the pool 20. A number of flow streams of a water circulation system are represented in the figures and are described below; tubing, pipes, hoses, fluid connectors, housings, and the like may be used to conduct the flow streams, for example, as is described herein.

The system 10 directs pool water 21 from the pool 20 into a pool stream 22. The pool stream 22 may be separated into a main stream 24 and a heated stream 26. Water in the heated stream 26 passes through a heater 28. The heater 28 heats water in the heated stream 26 to a temperature suitable to destroy at least some of the microbes in the water in the heated stream 26. Unlike the heated stream 26, water in the main stream 24 is not heated for antimicrobial purposes. After heating, water in the heated stream 26 may be recombined with water in the main stream 24 to create a merged stream 30. Water in the merged stream 30 then may be returned to the pool 20.

In this manner, the heated stream 26, having been heated to a temperature high enough to destroy microbes, but possibly too hot for comfortable or safe human contact, may be recombined with the cooler main stream 24 to provide a merged stream 30 that is at a temperature suitable for human contact. The resulting temperature of the water in the merged stream 30, which may be returned to the pool 20, will be less than the temperature of the water in the heated stream 26, but may be greater than the temperature of the water in the main stream 24. The temperature drop from the heated stream 26 to the merged stream 30 may also depend on the relative flow rates of the heated stream 26 and the main stream 24.

Some microbes, e.g., protozoa, are not particularly sensitive to chlorine, but are destroyed by moderate heat (around 150 degrees Fahrenheit). The system 10 has a particular advantage in such cases, as protozoan outbreaks are known to occur in swimming pools.

This configuration allows the system 10 to disinfect and to heat the pool water 21 using one combined process. The separation and recombination arrangement allows at least some of the pool water 21 to be disinfected at a temperature that is usually prohibited, because water at such a high temperature cannot be safely returned to the pool 20. However, by recombining the relatively hot water in the heated stream 26 with the cooler water in the main stream 24, the temperature of the merged stream 30 is low enough to be safely returned to the pool 20. The apparatus and process also may be used to disinfect fresh water that is added to a pool and to provide such water to the pool at a comfortable and/or safe temperature as a mixture in the merged stream 30.

Furthermore, the system 10 may accomplish the disinfecting and heating processes with equipment similar to equipment used in conventional pool, spa, or like water heater systems (conventional heater systems). Even though the water in the heated stream 26 is heated to a temperature that is higher than heated water in conventional heater systems, the system 10 may not have to use more total heat. The water in the merged stream 30 returning to the pool 20 may be at a temperature typical of return water in conventional heater systems. The heated stream 26 volume is only a portion of the volume of water in the pool stream 22. Therefore, instead of heating the entire pool stream 22, the lesser volume of water in the heated stream 26 can be heated to a much higher temperature using approximately the same number of BTUs as in a conventional heater system that heats all of the water withdrawn from and returned to a pool, spa, etc. The operating conditions of the heater 28 may be modified to heat a lesser volume of water to a higher temperature than in the conventional heater system, but total energy usage may be approximately equivalent. The system 10 may use the same capacity heater 28 and consume the same amount of energy as with a conventional heater system. Yet, in addition to heating, the system 10 is also disinfecting.

Pumping costs for the system 10 may be approximately the same as with a conventional heater system. The total flow rate of the pool stream 22 may be the same as the flow rate in a conventional heater system. Compared to a conventional water circulation system, the system 10 may require only minor changes in piping configurations that will allow the heated stream 26 to be isolated and heated independently of the main stream 24.

Moreover, the system 10 shown in FIG. 1 may decrease the requirements for antimicrobial chemicals to maintain microbes below a desired level. This will, in turn, decrease operating costs and may reduce the exposure of pool users to potentially irritating aspects of chlorinated water. Operating costs associated with antimicrobial chemicals occur in several areas: direct purchasing cost of chemicals; administering and maintenance; and/or equipment depreciation due to corrosive effects.

Referring now to FIG. 2, another embodiment of the antimicrobial water treatment system in accordance with the present invention is indicated at 10′. Pool water 21 from the pool 20 flows through a pool outlet 32 into the pool stream 22. The pool stream 22 then flows through a mechanical filter 34, e.g., a screen or other filtering device, for removing debris from the water in the system 10′. It is advantageous to remove debris from the pool water 21. For example, if the debris were biological and prone to decay, removal reduces contribution of such decay to the growth of microbes. Also, it may be advantageous to prevent debris from passing through the water treatment system 10′ to avoid damage to the system 10′ by foreign objects.

The mechanical filter 34 is optional and may be placed at various locations in the water flow paths. FIG. 2 shows two potential locations for the mechanical filter 34 with dashed boxes. However, these locations are only suggestive, and the mechanical filter 34 placement may be adapted to many different configurations. Also, if desired, there may be more than one mechanical filter 34, for example, each at a respective location in the water flow paths.

The pool stream 22 then flows through a pump 36. The pump 36 can be a conventional pump sized for similar flow rates and speeds common in conventional pool water heater systems. Pump 36 placement is shown in FIG. 2 to represent a typical location. However, this location is only suggestive, and pump 36 placement also may be placed in different locations.

The pool stream 22 then flows into a bypass valve 38. The bypass valve 38 separates the pool stream 22 into the main stream 24 and the heated stream 26. As mentioned above, water in the heated stream 26 passes through the heater 28 for antimicrobial heat treatment while water in the main stream 24 is not heated for antimicrobial purposes.

During heating, water in the heated stream 26 may be exposed to an antimicrobial chemical agent 40. The antimicrobial chemical agent 40 is optional, but can further reduce microbe levels in the water in the heated stream 26. Accordingly, the antimicrobial chemical agent 40 may be introduced using conventional disinfecting techniques at one or more locations throughout the system 10′. As an example, FIG. 2 shows the chemical agent 40 introduced after the heater 28, but it may also be introduced before the heater 28 or during the heating process. Antimicrobial chemical agents 40 may have enhanced effectiveness at eliminating microbes in water that is heated. Therefore, although the antimicrobial chemical agent 40 is optional, if it is used it is advantageous for it to be introduced as early as practical into the heated stream 26.

Adding a chemical agent 40 to the heated stream 26 will produce a local chemical concentration higher than that in the merged stream 30 or in the pool 20. This will allow the destruction of microbes that would otherwise be resistant to lower concentrations of disinfectant. The combination of heat, high antimicrobial chemical concentration, and prolonged contact in a storage vessel 42 will be more effective than either variable alone. The chemical concentration in the heated stream 26 could be higher than a human being could tolerate, and yet safe for a human after being diluted in the merged stream 30 before returning to the pool 20.

Using the antimicrobial chemical agent 40 to enhance the antimicrobial effectiveness of the system 10′ also may reduce the heater 28 operating temperature requirements. The operating temperature when no antimicrobial chemical agent 40 is added to the heated stream 26 may be, for example, about 125 to 260 degrees Fahrenheit; the operating temperature when the antimicrobial chemical agent 40 is added to the heated stream 26 may be, for example, about 105 to 260 degrees Fahrenheit. Generally, with all other variables constant, an increase in the heater 28 temperature or concentration of the antimicrobial chemical agent 40 increases the antimicrobial effectiveness of the system 10′. Using the antimicrobial chemical agent 40 in combination with the heater 28 can further increase the antimicrobial effectiveness of the system 10′. For various reasons, different combinations of heat and antimicrobial chemical agents may be useful in obtaining desired heating and disinfecting results of the system 10′. For example, a relatively small amount of antimicrobial chemical agent 40 in the heated water may significantly augment antimicrobial effectiveness. The amount of antimicrobial chemical agent 40 necessary to maintain acceptable microbe levels (e.g., less than 4 coliforms per 100 mL) would be less than what a conventional system, without heat treatment, would require to attain similar microbe levels.

Still referring to FIG. 2, the heated stream 26 then flows into the storage vessel 42. The storage vessel 42 is optional, but may further reduce microbe levels in the heated stream 26. The storage vessel 42 may be any appropriate apparatus, for example a storage tank or piping system, that allows water in the heated stream 26 to stay at an elevated temperature as long as possible. The storage vessel 42 provides added incubation time for the destruction of more microbes. Time and temperature are both variables contributing to antimicrobial effectiveness. Antimicrobial efficiency increases when water in the heated stream 26 is at an elevated temperature for a period of time longer than when no storage vessel 42 is used. The storage vessel 42 may be utilized whether or not the antimicrobial chemical agent 40 is used.

After the optional storage vessel 42, water in the heated stream 26 is recombined with water in the main stream 24 at a union 44. The output of the union 44 is the merged stream 30. Water in the merged stream 30 then may be returned to the pool 20 through a pool inlet 46.

A cooler 48 may also be used to reduce the temperature of the water in the heated stream 26, the merged stream 30, and/or any other stream in the system 10′. FIG. 2 shows two potential locations for the cooler 48 with dashed boxes. As an example, the cooler 48 may be located after the storage vessel 42 for maximum cooling effectiveness. In this manner, the user can heat or cool the pool water 21, or can use the heater 28 in combination with the cooler 48 to achieve desired levels of disinfection and temperature control. This allows additional operational control of the levels of disinfection and temperature. In particular, elevated heater 28 temperatures, followed by cooling, may be used for additional disinfection. The cooler 48 may be an air-cooled radiator, refrigeration unit, or any other device capable of cooling water. Use of the optional cooler 48 will require additional thermal energy input into the system 10′ when compared to the system 10′ without a cooler 48. This particular case is therefore an obvious exception to the statements made elsewhere that the invention requires little or no increase in heating costs. The cooler 48 may not be a widely used option. The cooler 48 would be advantageous, for example, in circumstances such as high ambient temperature, gross contamination, or when there is any reason to achieve greater disinfection than that provided by the system 10′ without a cooler 48.

A controller 50 may be used by the system 10′ to monitor various water temperatures, to regulate the flow rate of the heated stream 26 via the bypass valve 38, to regulate the heat output of the heater 28, and/or to regulate the cooling output of the cooler 48. Heat output, as it applies to this invention, is the thermal energy transferred from the heater 28 to the water. Similarly, cooling output is the thermal energy transferred from the water to the cooler 48.

The controller 50 can be any suitable programmable controller commercially available that has sufficient functions and is suitable for the pool 20 environment. For example, depending on the sophistication of the water treatment system 10′, the functions and features of the controller 50 may include input/output control, timers, memory for program and data storage, report generation, readout/display, safety controls, user-defined alarms, external communications, power failure recovery, etc.

Control of the basic system 10′ may involve three independent (controlling) variables and three dependent (controlled) variables. The independent variables are main stream 24 flow rate, heated stream 26 flow rate, and heater 28 energy input rate. The dependent variables are heater 28 temperature, merged stream 30 temperature, and pool water 21 temperature. The cooler 48 option may add another independent variable, the cooling rate, and another dependent variable, the cooler 48 temperature. It will be appreciated that the interaction between these variables may be considered. The temperature of the water flowing out of the heater 28, for instance, is primarily a function of heated stream 26 flow rate and heat output of the heater 28, but it is also a function of pool water 21 temperature. In the closed loop of the system 10′, each variable may affect another to some degree.

Design of the control system will therefore depend on the desired goals, the degree of sophistication of the controller 50, and expense. These issues and suitable programming of the controller 50 may be addressed by a person of ordinary skill trained in the art of programming controllers, computers, or the like.

Although a number of sensors and controller configurations are described below, it will be appreciated that the sensors and controllers may be optional, may be used alone, or may be used in various combinations that may be useful for any particular application to achieve desired results.

In an exemplary embodiment, the controller 50 may monitor a merged stream temperature sensor 52 and regulate the flow rate of the heated stream 26 via the bypass valve 38. The merged stream temperature sensor 52 measures the temperature of the water in the merged stream 30. The merged stream 30 flows directly into the pool 20. To increase the temperature of the water in the merged stream 30, the controller 50 may increase the flow rate of the heated stream 26 via the bypass valve 38. Similarly, to decrease the temperature of the water in the merged stream 30, the controller 50 may decrease the flow rate of the heated stream 26. In these instances, the heater 28 output temperature may remain constant. Other valving, which may provide on/off and/or flow rate or volume control, may be provided in one or more of the flow paths, an example being valves 53a, 53b respectively in the main and heated streams 24, 26.

The controller 50 may prevent water in the merged stream 30 from exceeding a suitable temperature for water returning to the pool 20, for example, about 106 degrees Fahrenheit. If the controller 50 senses that the temperature of the water in the merged stream 30 is greater than a threshold temperature, the controller 50 may shut down the heater 28 and pump 36 to ensure that unsuitably hot water does not return to the pool 20. The controller 50 may be programmed to anticipate expected temperature changes during control of the system 10′, thus minimizing the conditions where water in the merged stream 30 may exceed the threshold temperature.

In addition, the embodiment of the antimicrobial water treatment system 10′ shown in FIG. 2 includes a pool water temperature sensor 54, a heated stream temperature sensor 56, and a heater 28 with variable heat output. The pool water temperature sensor 54 allows the controller 50 to monitor the temperature of the pool water 21. The heated stream temperature sensor 56 allows the controller 50 to monitor the temperature of water in the heated stream 26 after the water is heated by the heater 28. These additional sensors may provide inputs to the controller 50 for use in regulating the flow rate of the heated stream 26 via the bypass valve 38. Also, an output of the controller 50 may be used to allow the controller 50 to regulate the heat output of the heater 28. This additional variable provides more control over the amount of heat transferred to the water in the heated stream 26.

FIG. 2 also includes a cooler 48 with variable cooling output, e.g., cooling rate or cooling effect. In another embodiment, the controller 50 may have an additional output to control the cooler 48 output, which allows the system 10′ to lower the temperature of the heated stream 26, merged stream 30, and/or any other flow stream. It will be apparent that the addition of the cooler 48 with variable cooling output allows for various combinations of heating and cooling for a multitude of pool water 21 disinfection and temperature needs. The system 10′ may also include a cooler water temperature sensor 57 in the stream after the cooler 48 to allow the controller 50 to monitor the temperature of the water coming out of the cooler 48.

It also should be apparent that there are many combinations of temperature inputs and controller outputs that may be useful to achieve desired pool water 21 temperatures, disinfection efficiencies, and/or operating costs. The embodiments suggested here do not reflect all of the possible combinations of controller 50 inputs and outputs that may be useful. Furthermore, sensors detecting other parameters, such as turbidity, pH levels, ambient air temperature, etc., may be incorporated with additional benefits. Similarly, it may be useful for the controller 50 to regulate other parameters or devices, such as pump speed, additional heaters, additional coolers, etc.

During use, the system 10′ may achieve antimicrobial and heating results similar to a conventional pool water treatment system. The pump 36 may continually circulate pool water 21 through the system 10′. The controller 50 can regulate how much water from the pool stream 22 is directed into the heated stream 26, how much heat is output from the heater 28, and how much cooling is output from the cooler 48. In this manner, the system 10′ can destroy microbes in the pool water 21 with or without an increase in pool water 21 temperature. The controller 50 can regulate the system 10′ to achieve temperature targets set by the user, entered either manually or programmed into the controller 50. For example, the user may enter a desired pool water temperature, merged stream water temperature, and/or heated stream water temperature. However, these suggested user inputs are merely exemplary parameters described in this embodiment. The system 10′ may be capable of responding to fewer, more, and/or other user desired parameters that may be useful for any particular application. The controller 50 can regulate the system 10′ to achieve the desired temperatures while preventing water temperatures from exceeding the safety temperature thresholds set for the pool water 21 and/or the returning water in the merged stream 30.

The choice of operating conditions may depend upon the goals, the specific microbes involved, and/or the condition of the water being disinfected. Generally, operation at about 140-150 degrees Fahrenheit will kill most coliform organisms. Particularly resistant microbes may require much higher temperatures. Operation at higher temperatures, while more effective, may be performed on a lower flow rate of water in the system 10′.

As an example, consider that the volume of the pool 20 is circulated through the system 10′ every eight hours. If the heater 28 handles one third of the pool stream 22, the volume of the pool 20 will have been disinfected every day. Obviously, the pool 20 may not be completely disinfected, since the merged stream 30 blends back with the pool 20 that is contaminated to some degree.

Chemical disinfection at an elevated temperature and elevated concentration may enhance the effectiveness of the system 10′. A storage vessel 42 of any size also adds to the disinfecting time and therefore the effectiveness. The cooler 48 may be used where higher heater 28 temperatures are necessary because of gross contamination, resistant microbes, high ambient temperatures, and/or a general need to achieve maximum effectiveness.

The present invention may be able to achieve improvements in operating costs and disinfection when compared to conventional pool water treatment systems. The system 10′ is capable of continuously destroying microbes from pool water 21, possibly with reduced use of chemical agents, and simultaneously heating and/or cooling the pool water 21 to desired user temperatures. Moreover, the system 10′ may achieve these objectives with little or no increase in operating costs.

While this invention has been described with respect to various examples and embodiments, it is to be understood that the invention is not limited to only those embodiments and that it can be variously practiced within the scope of the following claims.

What is claimed is:

1. An antimicrobial water treatment system, comprising:
a water container adapted for full or partial immersion therein of a human or other animal; and
a heater to heat at least some of the water of the container to a temperature adequate to destroy at least some microbes in the water.

2. The antimicrobial water treatment system as set forth in claim 1, further comprising:
a water circulation system fluidically coupled to the water container such that water flows from the water container, through the water circulation system, and back to the water container.

3. The antimicrobial water treatment system as set forth in claim 2, wherein the water circulation system is adapted to separate water flowing through the water circulation system into a main stream and a heated stream, and wherein water in the heated stream is heated to the temperature adequate to destroy at least some microbes in the water.

4. The antimicrobial water treatment system as set forth in claim 3, wherein the main stream is recombined with the heated stream to create a merged stream after the water in the heated stream is heated.

5. The antimicrobial water treatment system as set forth in claim 4, wherein the container is a pool or spa, water from the container is provided to the main stream from the pool or spa, and the merged stream is provided to the pool or spa.

6. The antimicrobial water treatment system as set forth in claim 4, further comprising:
a bypass valve adapted to control the flow of water from the water circulation system to the heated stream;
a merged stream temperature sensor to monitor the merged stream water temperature before the water returns to the water container; and
a controller adapted to regulate the bypass valve as a function of the merged stream water temperature.

7. The antimicrobial water treatment system as set forth in claim 6, further comprising:
a container water temperature sensor, wherein the controller additionally monitors the container water temperature.

8. The antimicrobial water treatment system as set forth in claim 6, further comprising:
a heated stream temperature sensor, wherein the controller additionally monitors the heated stream water temperature after the water is heated.

9. The antimicrobial water treatment system as set forth in claim 6, wherein the controller additionally regulates the heat output of the heater.

10. The antimicrobial water treatment system as set forth in claim 6, further comprising:
a container water temperature sensor; and
a heated stream temperature sensor,
wherein the controller additionally monitors the container water temperature and the heated stream water temperature after the water is heated and additionally regulates the heat output of the heater.

11. The antimicrobial water treatment system as set forth in claim 4, further comprising:
an antimicrobial chemical agent adequate to destroy at least some microbes in the water.

12. The antimicrobial water treatment system as set forth in claim 11, wherein the antimicrobial chemical agent adequate to destroy at least some microbes in the water is introduced in the heated stream.

13. The antimicrobial water treatment system as set forth in claim 4, further comprising:
a storage vessel adapted to maintain the water in the heated stream at an elevated temperature.

14. The antimicrobial water treatment system as set forth in claim 2, further comprising:
a mechanical filter adapted to remove debris from the water in the water circulation system.

15. The antimicrobial water treatment system as set forth in claim 2, further comprising:
a cooler adapted to cool the water in the water circulation system.

16. The antimicrobial water treatment system as set forth in claim 15, further comprising:
a cooler water temperature sensor to monitor the temperature of the water coming out of the cooler; and
a controller adapted to regulate the cooling rate of the cooler as a function of the temperature of the water coming out of the cooler.

17. The antimicrobial water treatment system as set forth in claim 2, further comprising:
an outlet adapted to direct water from the water container to circulate through the water circulation system;
a pump adapted to circulate the water through the water circulation system;
tubing adapted to pass the water through the water circulation system; and
an inlet adapted to direct water from the water circulation system to return to the water container.

18. A method of reducing microbes in water of a water container adapted for full or partial immersion therein of a human or other animal, comprising the step of:
heating at least some of the water to a temperature adequate to destroy at least some microbes in the water.

19. The method of claim 18, further comprising the step of:
passing water in the water container through a water circulation system.

20. The method of claim 19, further comprising the steps of:
removing water from the water container using the water circulation system; and
returning the water to the water container using the water circulation system.

21. The method of claim 19, further comprising the step of:
separating the water flowing through the water circulation system into a main stream and a heated stream, wherein water in the heated stream is heated to the temperature adequate to destroy at least some microbes.

22. The method of claim 21, further comprising the step of:
recombining the heated water in the heated stream with the water in the main stream to create a merged stream.

23. The method of claim 22, further comprising the steps of:
monitoring the merged stream water temperature before the water returns to the water container; and
regulating the heated stream flow rate to achieve a desired level of heating.

24. The method of claim 23, further comprising the step of:
monitoring the water container water temperature.

25. The method of claim 23, further comprising the step of:
monitoring the heated stream water temperature.

26. The method of claim 23, further comprising the step of:
regulating the heat output of a heater.

27. The method of claim 23, further comprising the steps of:
monitoring the water container water temperature;
monitoring the heated stream water temperature; and
regulating the heat output of a heater.

28. The method of claim 21, further comprising the step of:
exposing at least some of the water to an antimicrobial chemical agent adequate to destroy at least some microbes.

29. The method of claim 21, further comprising the step of:
exposing the water in the heated stream to an antimicrobial chemical agent adequate to destroy at least some microbes in the water in the heated stream.

30. The method of claim 21, further comprising the step of:
storing the water in the heated stream at an elevated temperature to further destroy microbes.

31. The method of claim 19, further comprising the step of:
passing the water in the water circulation system through a mechanical filter adapted to remove debris.

32. The method of claim 19, further comprising the step of:
cooling the water in the water circulation system in order to destroy more microbes by operating the heater at a higher temperature.

33. The method of claim 32, further comprising the steps of:
monitoring the temperature of the water coming out of a cooler; and
regulating the cooling rate of the cooler as a function of the temperature of the water coming out of the cooler.
